(19) United States
(12) Patent Application Publication
(10) Pub. No.: US 2008/0273958 A1
(43) Pub. Date: Nov. 6, 2008

(54) Mattress overturning device in hemming machines

(75) Inventors: Roberto Resta, Faenza (IT); Paolo Resta, Faenza (IT)

Correspondence Address: MODIANO & ASSOCIATI, Via Meravigli, 16, MILANO, 20123, IT

(73) Assignee: RESTA S.R.L.

(21) Appl. No.: 12/149,299

(22) Filed: Apr. 30, 2008

(30) Foreign Application Priority Data
May 3, 2007 (IT) BO2007A000320

(51) Int. Cl. B65G 47/248; D05B 11/00; B65G 47/252

(52) U.S. Cl. 414/759; 112/2.1; 198/403

(57) ABSTRACT

A device for overturning mattresses in a hemming machine, comprising a worktable which has an inner side and an outer side, a sewing machine to perform the perimetric hemming of the mattress and an assembly for orienting the mattress on the worktable being arranged on the inner side, and further comprising an articulated arm, which is arranged on the outer side of the worktable and is provided with grippers for gripping a mattress, the arm being able to oscillate between a position for gripping the mattress and a position for releasing the mattress after a rotation sufficient to overturn the mattress.

The present invention relates to a device for overturning mattresses in hemming machines.

### BACKGROUND OF THE INVENTION

As is known, the case that contains mattresses is constituted by two panels which cover the opposite faces of the mattress and by a perimetric band which is joined to the panels with the aid of a tape which is sewn so as to straddle the adjacent edges of the panels and of the band.

A stationary sewing machine is normally used to sew the tape, and the mattress is pushed and turned manually with respect to the sewing machine on a worktable, with considerable effort on the part of the operator.

In order to facilitate the work of the operator, the worktable is often constituted by a roller bed, and while the advancement of the mattress occurs by the means of the traction performed by the sewing machine, the rotation of the mattress with respect to the sewing machine in order to hem the perpendicular sides and corners of the mattress is performed by means of an appropriately provided orientation device. A device of this type is disclosed for example in EP 682135 in the name of this same Applicant.

This patent also discloses a device which allows to overturn the mattress when the sewing of a perimetric hem of one face has ended, so as to perform the perimetric sewing of the opposite face.

The overturning device disclosed in EP682135, when not active, is accommodated between the rollers that form the worktable and therefore cannot be used in cases in which the worktable is constituted by a moving belt.

GB 1,144,954, U.S. Pat. No. 3,490,061 also disclose a mattress overturning device for hemming machines which have a worktable constituted by a moving belt. However, such overturning device can be used only in hemming machines of a different concept, in which the mattress, during hemming, remains stationary and the sewing machine moves around it.

### SUMMARY OF THE INVENTION

The aim of the present invention is to provide a device which allows the overturning of the mattress even in hemming machines in which the sewing machine is stationary but at the same time can be used both if the worktable is of the roller type and if it is of the moving belt type.

Within this aim, an object of the present invention is to provide a device which is structurally simple and therefore cheap and highly reliable in operation.

This aim and this and other objects which will become better apparent hereinafter are achieved with a device whose characteristics are defined in the claims that follow.

### BRIEF DESCRIPTION OF THE DRAWINGS

Further characteristics and advantages of the invention will become better apparent from the following detailed description of a preferred embodiment thereof, illustrated by way of non-limiting example in the accompanying drawings, wherein:

FIG. 1 is a side view of the overturning device in three distinct operating positions;

FIGS. 2, 3, 4 and 5 are plan views of the device in successive operating positions.

### DESCRIPTION OF THE PREFERRED EMBODIMENTS

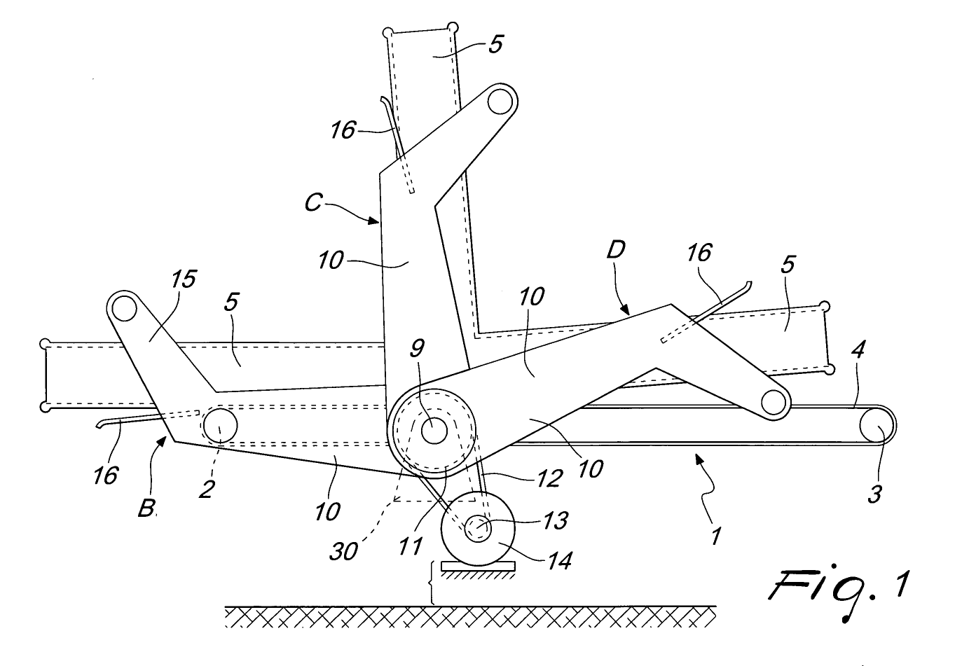

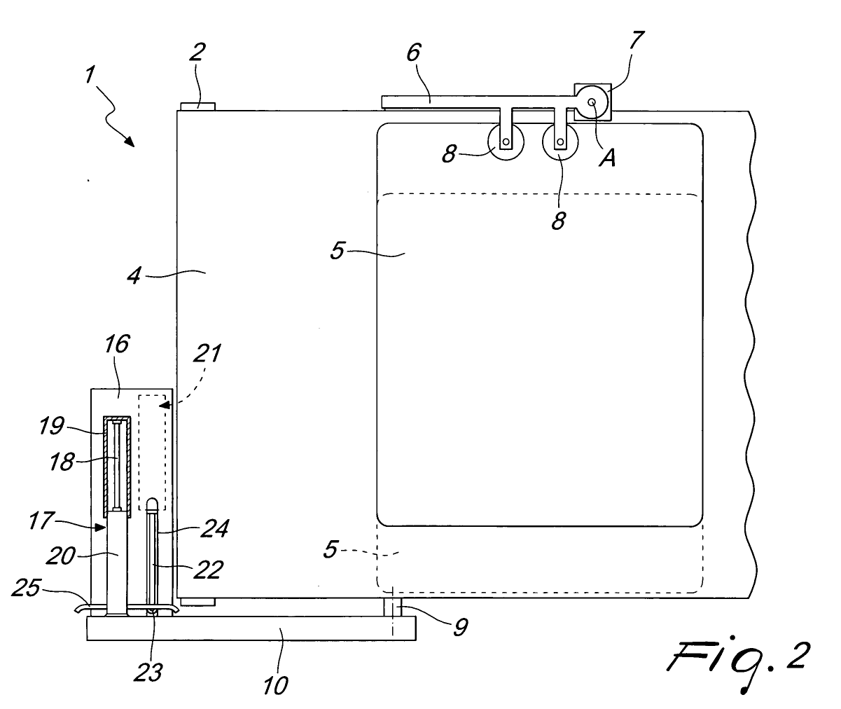

With reference to FIGS. 1 and 2, the reference numeral 1 generally designates a belt which is closed in a loop around a pair of mutually parallel rollers 2, 3, one of which is connected to a motor, which is not shown. An upper portion 4 of the belt 1 constitutes the worktable of the hemming machine on which a mattress 5 is moved, i.e., made to advance and rotate, in order to provide the hem.

A frame 7, for supporting and positioning a sewing machine which forms the hem of the mattress and the elements intended to move and orient the mattress, is arranged on a first side of the belt 1 (see FIGS. 2-5) where the operator of the hemming machine is generally located and which, for the sake of convenience in description, is referenced hereinafter (and in the appended claims) as the inner side. The “outer side” or second side of the belt 1 (worktable) will be the side opposite to the inner side. Of such frame, which is not shown in full in the drawings since it has a traditional construction, as described and illustrated for example in the already cited EP682135, only a motorized arm 6 is shown and is supported on a column so that it can swing about a vertical axis A and is provided with a pair of pneumatic pressers 8 which are adapted to lock the mattress 5 on the worktable 4 in order to be able to turn it about the vertical axis A when the arm 6 is actuated.

A shaft 9 is supported on a support 30 located below the worktable 4, is parallel to the rollers 2, 3 and protrudes from the outer side of the belt 1 which is arranged opposite the frame 7. An arm 10 and a sprocket 11 adjacent thereto are jointly connected for rotation on the shaft 9. A chain 12 meshes with the sprocket 11 and is closed in a loop around a pinion 13 which is keyed to the axis of an actuation motor 14 installed below the belt 1. The motor 14 is capable of imparting to the arm 10 mutually opposite angular strokes, so as to determine in practice an oscillation of approximately 180° and therefore the overturning of the arm 10 between two final positions which are laterally adjacent to the outer side of the worktable 4.

The arm 10 comprises an angled end portion 15, from which a flat bracket 16 protrudes in a cantilever fashion. The bracket 16, with respect to the shaft 9, is at a greater distance than the roller 2, so that in a final position of the arm 10 it forms a sort of extension of the worktable 4, while in the other final position it is superimposed on the worktable 4.

A hydraulic jack 17 is rigidly coupled to the angled portion 15 and is provided with a stem 18 which extends within a tube 19, which is guided on a cylinder 20 of the jack and is jointly connected in a cantilever fashion to the end of the angled portion 15. The jack 17 has an axis which is parallel to the shaft 9 and a distance from the bracket 16 which is greater than the thickness of the mattress 5, so that the mattress, when the bracket 16 is coplanar with respect to the worktable 4, can be inserted between the bracket 16 and the tube 19.

A second hydraulic jack 21 is fixed below the bracket 16, is parallel to the preceding one and has a stem 22 which extends toward the arm 10. A T-shaped member 23 is connected to the end of the stem 22 and by way of the movement of the stem can move along a straight slot 24 of the bracket 16. A plate 25 is fixed to the T-shaped member 23, is perpendicular to the stem and can move, acting as a pusher, above the bracket 16 and below the jack 17 between a position for alignment with the outer edge of the belt and a position arranged inside the worktable 4.

The operation of the described device is as follows.

An initial situation is assumed in which hemming of the upper face of the mattress 5 is assumed to have ended. This situation is shown in FIG. 2, in which the mattress 5 is again arranged with its short side adjacent to the frame 7 for supporting the sewing machine and aligned with the internal edge of the worktable, along which it is made to advance during hemming. During hemming, the arm 10 of the device is overturned in the parking position in which the bracket 16 is coplanar to the worktable 4 and the tube 19 is at a height, with respect to the worktable 4, which is greater than the thickness of the mattress 5, so as to allow insertion of the mattress between the bracket 16 and the tube 19 when it is necessary to proceed with the overturning of the mattress. This parking situation is designated by the reference letter B in FIG. 1. It should be noted that in this situation the pressers 8 are raised with respect to the mattress in order to allow freedom of movement thereof on the worktable, while the jacks 17 and 21 are elongated so that the plate 25 is substantially aligned with the outer edge of the belt 1 that lies opposite the sewing machine and the tube 19 is extended until it interferes with the advancement front of the mattress.

Once the hemming of one face of the mattress has ended, in order to be able to proceed with the hemming of the opposite face, the operator, either manually or by means of an appropriately provided pusher, moves the mattress away from the sewing machine and positions it until the edge that lies opposite the sewing machine is aligned with the plate 25, as shown in broken lines in FIG. 2.

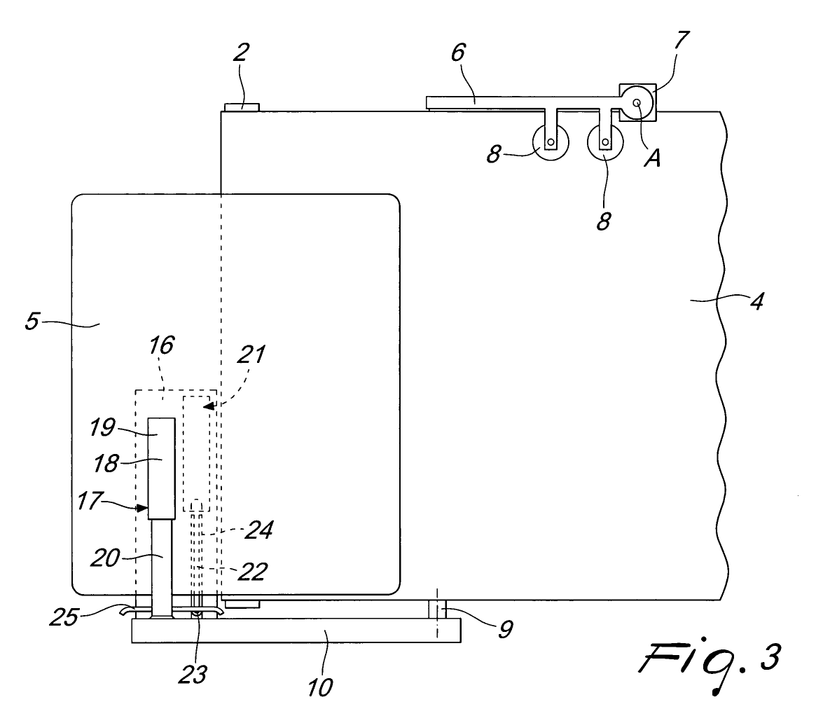

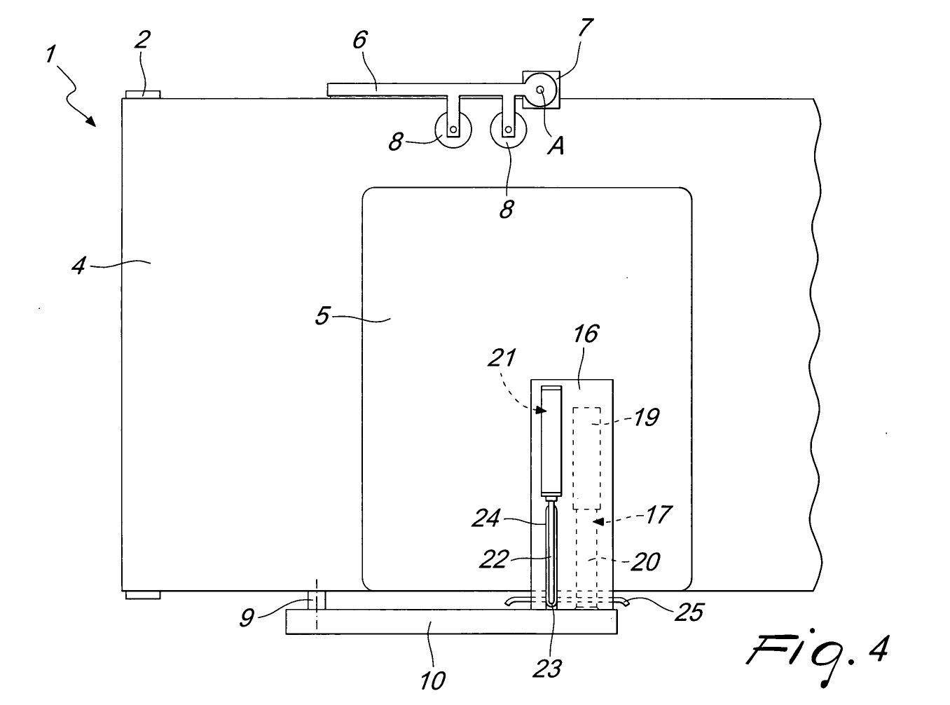

By way of the actuation of the belt 1, the mattress 5 is then made to advance until its front end is inserted between the tube 19 and the bracket 16 (FIG. 3). When the rear end of the mattress is at, or has passed beyond, the axis 9 of the arm 10, the motor 14 is activated and, by means of the transmission 11-13, imparts to the arm 10 a 180° rotation which first produces the straightening in a vertical position (position C of FIG. 1) and then the overturning of the mattress 5 on the worktable (position D of FIG. 1 and FIG. 4).

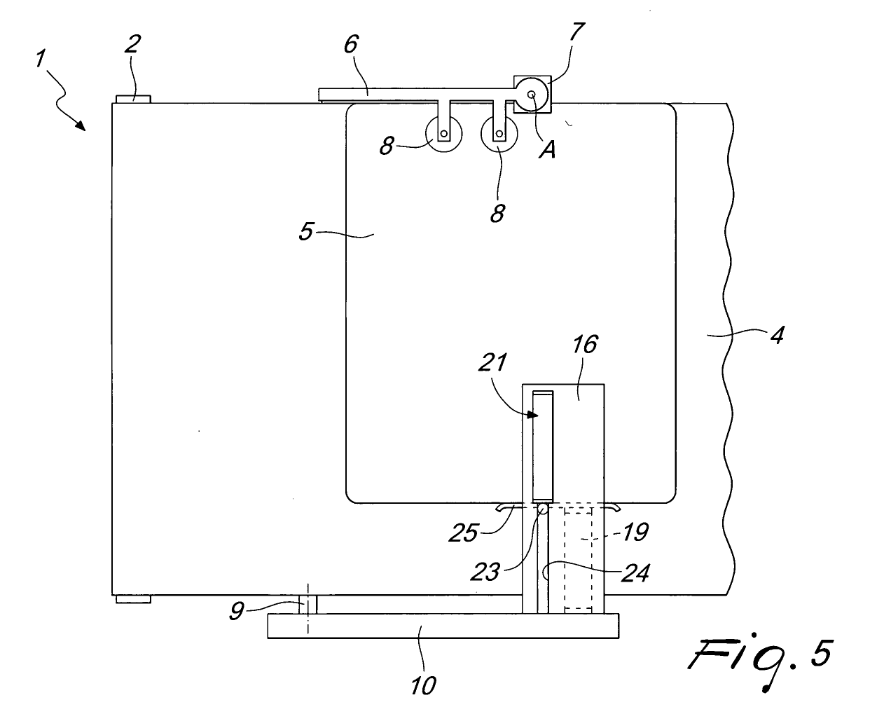

At this point, the jack 21 is activated and, by means of the pusher plate 25, acts on the edge of the overturned mattress, so as to move the mattress 5 transversely on the worktable 4 and move it closer to the sewing machine, so that the assigned operator can perform hemming of the opposite face of the mattress (FIG. 5).

It is noted that since in the position D the tube 19 is arranged below the mattress (FIG. 1), the jack 17 is also activated simultaneously with the jack 21, so that by returning the tube 19 onto the cylinder of the jack 17 the mattress 5 can rest completely on the worktable 4 and allow a regular movement and exact positioning of the mattress with respect to the sewing machine on the part of the operator and the execution of perfect hemming.

Finally, while final hemming proceeds, the arm 10 is inverted again in the initial position B of FIG. 1 in order to be ready to proceed with the overturning of subsequent mattresses.

As can be seen, the described device achieves the intended aim and objects. In particular, it allows to overturn mattresses even when the worktable is constituted by a roller bed.

The described device is susceptible of numerous modifications and variations, all of which are within the scope of the appended claims. In particular, in order to ensure better grip of the mattress on the tube 19 during overturning, said tube is provided with a surface covering of friction material.

Another improvement consists in using on the bracket 16 means which are adapted to form with the tube 19 a sort of clamp which grips and retains the mattress during the overturning step.

Another improvement of the device provides, in order to actuate the arm 10, instead of the transmission 11-14, a mechanism which is composed of a lever which is radially jointly connected to the shaft 9 and is associated with a hydraulic actuator so as to impart to the arm 10 the oscillation through approximately 180°.

The disclosures in Italian Patent Application No. B02007A000320 from which this application claims priority are incorporated herein by reference.

What is claimed is:

1. A device for overturning mattresses in a hemming machine that comprises a worktable having an inner side and an outer side, a sewing machine for performing a perimetric hemming of a mattress arranged on said worktable and an assembly for orienting the mattress on the worktable being arranged on the inner side, the device comprising: an articulated arm, which is arranged on the outer side of the worktable; grip means for gripping a mattress that are provided on said articulated arm; and a support for supporting said arm so as to be oscillatable between a position for gripping and a position for releasing the mattress after a rotation thereof sufficient to overturn the mattress.

2. The device of claim 1, wherein said grip means are constituted by a bracket which is mounted on and so as to protrude at right angles from a free end of said arm, and by a supporting element which is rigidly coupled to a region of said arm at such a distance from said free end thereof where said bracket is mounted as to allow insertion of the mattress between said bracket and said supporting element when said arm is in the position for gripping the mattress.

3. The device of claim 2, comprising a pusher that is connected with said grip means and is actuatable so as to act on the mattress after overturning thereof in order to move the mattress closer to the sewing machine.

4. The device of claim 3, wherein said supporting element is constituted by a hydraulic jack, which comprises a cylinder that is rigidly coupled in a cantilever fashion to said free end of said arm so as to protrude above said worktable and by a tube which is slidable on said cylinder, said cylinder being provided with a stem which extends within said tube, and said tube being slidable on said cylinder so as to move at a distance from said bracket which is greater than a thickness of the mattress and being retractable on said cylinder when said arm is in a position corresponding to said position for releasing the overturned mattress.

5. The device of claim 4, wherein said pusher comprises a hydraulic jack which is arranged on a side of the bracket that lies opposite a side thereof on which said tube is arranged, said jack being provided with a stem, having free end with a plate connected thereto, through a slot provided on said bracket, said plate being movable between said bracket and said tube and being adapted to act on the mattress being in said position for releasing after overturning thereof, in order to move the mattress closer to the sewing machine.

6. The device of claim 1, comprising an actuation motor, said arm being jointly connected to a shaft supported by said support, said shaft being provided with a sprocket that is keyed thereon, a chain being further provided that is closed in a loop around a pinion so as to mesh with said sprocket, said pinion being keyed to the axis of the actuation motor.
